(19) United States
(12) Patent Application Publication
(10) Pub. No.: US 2018/0365852 A1
(43) Pub. Date: Dec. 20, 2018

(54) SYSTEM AND METHOD FOR LOCATING BY IMAGE PROCESSING

(71) Applicant: Airbus SAS, Blagnac (FR)

(72) Inventors: Denis MARRAUD, ISSY LES MOULINEAUX (FR); Benjamin CEPAS, SURESNES (FR); Xavier PERROTTON, CHATILLON (FR); Nicolas BOURDIS, PUTEAUX (FR)

(21) Appl. No.: 16/006,062

(22) Filed: Jun. 12, 2018

(30) Foreign Application Priority Data
Jun. 14, 2017 (FR) 1755331

(51) Int. Cl. G06T 7/70; G06T 19/00

(52) U.S. Cl. CPC G06T 7/70; H04W 88/02; G06T 19/006

(57) ABSTRACT

A system for locating at least one object in a real space by image processing, comprises a computation center (center), with a database of a virtual environment, a virtual representation of the real space, and computing the position of a point from which the virtual environment appears on a real space image obtained by an image acquisition device borne by the object. The center is sited remotely from the object. A data transmission device transfers the image data from the object to the center and the location data from the center to the object. The center processes the image data to determine a position from which the image was acquired, and stores, in a complementary database, data of the processed image to complement and/or to correct an initial database. The locating system implements a locating method for locating and transmitting the location data to a plurality of real environment objects.

### CROSS-REFERENCES TO RELATED APPLICATIONS

This application claims the benefit of the French patent application No. 1755331 filed on Jun. 14, 2017, the entire disclosures of which are incorporated herein by way of reference.

### FIELD OF THE INVENTION

The invention belongs to the field of the locating of an object or of a part of an object in space.

The invention relates, in particular, to the accurate locating of a position in space, from a point of observation, by the processing of images observed from the point to be located.

More particularly, the invention is applicable in the locating of machines moving around in a complex and potentially variable environment, for example, an industrial workshop environment in which large structures are assembled.

### BACKGROUND OF THE INVENTION

In many fields of industry, it is necessary to continually locate an object, or at least a point of an object, in space when the position of the object is required to change.

There are, for that purpose, many solutions for identifying the position of the object in relation to a local environment, local positioning or in relation to a reference considered as absolute, such as, for example, a terrestrial marker, or global positioning.

Thus, for example, there are locating systems based on measurement, implementing in particular sensors of distance in relation to reference points or surfaces, triangulation systems implementing sites on targets having known positions and trilateration systems based on measurements of dates and/or of phases on signals received from several sources, as in satellite locating systems.

These locating systems general exhibit limitations linked to the environments in which they can be implemented reliably and to their complexity, and to their intrinsic spatial resolutions.

More recently, advances in the digital imaging and digital processing of images have made it possible to determine a location by shape recognition on images, these being solutions seeking to mimic the operation, at least the result, of the combined work of the human or animal eye and brain, which is capable of determining location by observing what is seen and approximating this to previously acquired images.

However, other than by obtaining a perfect superposition of what is seen with what has been memorized previously, it is necessary to apply corrections which can become very demanding in terms of computation powers and computation times, particularly when the objects or shapes observed exhibit variations of appearance that can change from one observation to another, for example of shape, or of color, or of lighting, or of relative position in relation to other objects or to an environment.

The various locating solutions can be combined, when they are usable, to allow instances of location in larger volumes or more precise volumes, but the complexity and the performance of these systems do not, these days, suit all applications and, in particular, an industrial environment where robots and robotized tools working, for example, on complex and fragile structures have to move around, as, for example, in the case of aircraft assembly lines.

### SUMMARY OF THE INVENTION

The present invention provides an enhancement to known prior art solutions through the implementation of a system and a method in which a remote image processing performs locating computations for the benefit of any number of objects and constantly enhances the virtual environment implemented for the locating computations.

To locate at least one object in a real space by image processing, the locating system of the invention comprises a computation center, the computation center comprising at least one database of a virtual environment, a virtual representation of the real space, and comprises at least one image acquisition device intended to be borne by the at least one object.

The locating of the at least one object comprises the computation of a position of a point of the virtual environment from which the virtual environment is seen as represented on at least one image of the real space obtained by the at least one image acquisition device.

Furthermore:

the computation center is remotely-sited relative to the at least one image acquisition device and the locating system comprises a data transmission device performing the transfer of data representative of images from the at least one image acquisition device to the computation center and the transfer of location data from the computation center to the image acquisition device,

the computation center is configured to perform a processing of the data, representative of an image of the real space transmitted by the at least one image acquisition device, to determine, in the virtual environment, a position of a point of the real space from which the image was acquired, and transmits, to the at least one image acquisition device, location data of the point comprising data of the position,

the computation center is configured to store, in a complementary database, data of the image of the real space processed, acquired by the image acquisition device, which complement and/or correct an initial database of an initial digital representation of the real space to constitute the database of an enhanced digital representation of the real space.

In this arrangement of the locating system, the means implemented for the storage of the database of the virtual representation of the space, for the manipulation of this database and for the processing of the images, are advantageously remotely-sited from the object to be located, which facilitates the remote installation without a limitation on weight and volume of the means of the computation center, to the benefit of processing capacity and processing speed, which would, in practice, be limited in a solution embedded on the object. Furthermore, the concentration of the images processed by the computation center simultaneously makes it possible to enrich the content of the database and to enhance the virtual representation of the real space from the images implemented for the locating computations, such an enhancement benefiting any object having to be located by the system in the real space.

In one embodiment, the computation center also performs a processing of the data, representative of an image of the real space transmitted by the at least one object, to determine, in the virtual environment, a direction of an axis of observation towards which the real space is viewed, from the point of the real space from which the image was acquired, and transmits, to the at least one object, the location data of the point comprising direction data of the axis of observation.

There is thus determined, not only the position of the image acquisition device, but also its orientation in the real space, from which the orientation of the object is deduced by the alignment of the image acquisition device relative to a body of the object.

In one embodiment, the locating system comprises a plurality of image acquisition devices, intended to be borne by objects situated in the real space at one and the same instant and/or at different instants.

Benefit is thus derived from the processing of a larger number of images taken from different locations of the real space and/or at different moments to enhance the database implemented for the locating computations.

Advantageously, the data transmission device is a wireless transmission device.

In one embodiment, the locating system comprises at least one autonomous locating device intended to be borne by the at least one object and associated with the image acquisition device so as to generate, for each image, primary location data associated with the data representative of the image.

In one embodiment, the image acquisition device intended to be borne by the at least one object is a video camera delivering data in two dimensions, 2D, and/or a depth camera delivering data in three dimensions, 3D.

It is, in this way, possible to transmit a stream of images which make it possible to follow the position of the object in the real space when the object bearing the image acquisition device moves.

In one embodiment, the system also comprises a supervision station which uses the database of the virtual environment and the location data of the object or objects bearing image acquisition devices to reconstruct, on one or more screens, a visual representation of the virtual space, comprising representations of structures and of objects of or in the real space, seen from at least one point of observation set arbitrarily or chosen by an operator.

The invention also addresses a method for locating at least one object in a real space in which the at least one object is located.

The method comprises:

a) a preliminary step of creation of a digital model of an initial virtual representation of the real space, hosted in a database of a computation center separate from the at least one object, then;

b) a step of transmission, to the computation center, of data representative of an image of the real space acquired from a point of observation linked to the object, then;

c) a step of processing, by the computation center, of the data representative of the image to determine, in the initial virtual representation of the real space or in an enriched virtual representation of the real space, a position from which the image was formed in the real space, and;

d) a step of enrichment of the digital model of the initial or enriched virtual representation of the real space by incorporation, in the digital model, of data of the real space extracted from the data representative of the image transmitted in the transmission step.

In one implementation of the method, the step of processing by the computation center of the data representative of the transmitted image comprises determining, in the virtual representation of the real space, a direction of an axis of observation towards which the real space is viewed, from the point of the real space from which the image was acquired.

In one implementation, the method, after the processing step, comprises a step of transmission, by the computation center to the object concerned, of location data comprising position data determined in the processing step, from which the image was formed in the real space, if appropriate, direction data of an axis of observation.

In one implementation of the method, the data of the real space, incorporated in the step of enrichment in the digital model of the virtual representation of the real space, comprise primitives generated from appearance attributes out of contrasts, colors, transparencies, reflections, textures, depth measurements.

In one implementation of the method, the data of the real space, incorporated in the step of enrichment in the digital model of the virtual representation of the real space, comprise data relating to structures of the real space added to and/or deleted from and/or moved in the real space.

In one implementation of the method, images of the real space are acquired successively from a point of observation linked to the at least one object and transmitted sequentially to the computation center and the steps of processing and of enrichment are performed recurrently with all or some of the images transmitted sequentially.

In one implementation of the method, a plurality of objects are located simultaneously and/or sequentially.

In one implementation of the method, the data stored in the complementary database are aggregated and conserved in an enrichment log of the initial database.

### BRIEF DESCRIPTION OF THE DRAWINGS

The invention is described with reference to the figures which are given as a non-limiting example of an embodiment of the invention, which schematically represents:

FIG. 1 is an illustration of an example of a locating system according to the invention applied to the case of a space determined by the volume of a workshop hangar in which an airplane is placed.

FIG. 2 is a simplified flow diagram of the locating method according to the invention.

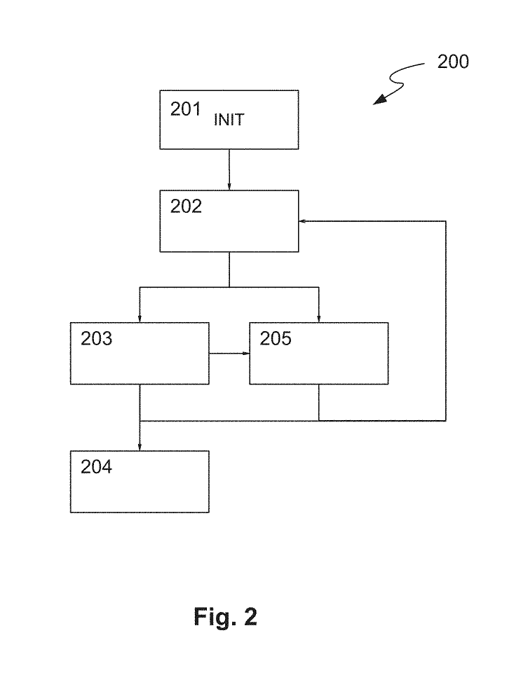

In the figures, the drawings are not necessarily represented to the same scale.

### DETAILED DESCRIPTION OF THE PREFERRED EMBODIMENTS

The invention relates to a device and a method for locating an object 30 in a space 10 by optical recognition.

The invention is described in the example of locating in a space defined by a footprint on the ground 11 and a height H, for example the surface on the ground and the height of an industrial building, which can be of large dimensions, but for which the roundness of the Earth is negligible, and a locating in the space will be considered with a Cartesian reference frame OXYZ whose orientation in a vertical direction is independent of the location of the origin O of the reference frame in the space, a vertical which, according to the hypothesis made, will be considered as the invariable vertical of a local terrestrial reference frame of the space considered.

This hypothesis is naturally a simplifying hypothesis, valid in general in the conditions of the exemplary embodiment and implementation which will be described, and the person skilled in the art will apply the equations taking into account the roundness of the Earth in the case of an application for which this simplifying hypothesis would no longer be satisfactory.

For the needs of the description, the reference frame OXYZ corresponds to a conventional system of axes with a horizontal axis X, a vertical axis Z oriented positively upwards and an axis Y, at right angles to a plane defined by the directions of the axes X and Z.

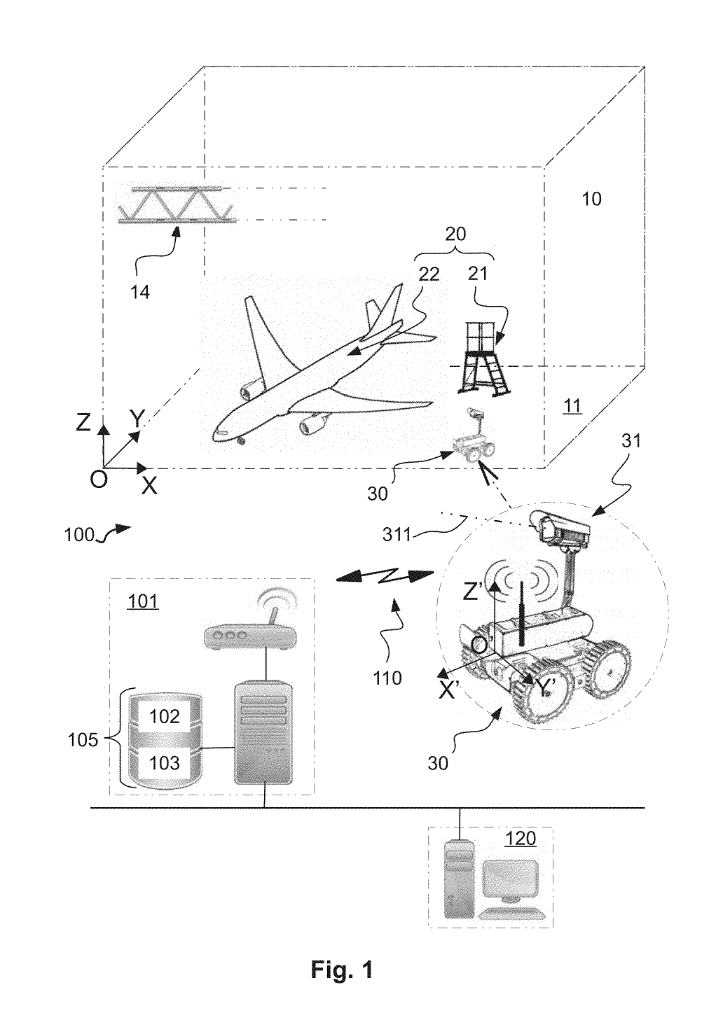

FIG. 1 symbolically represents a real space 10 in which one or more objects 30 have to be located.

The space 10 corresponds to a volume in which fixed primary structures 14 are situated, for example structures of a building protecting the space, or of buildings situated in the space, even at the periphery of the space, and/or potentially mobile secondary structures 20, for example tool rigs 21, all or part of which can be moved within the reference frame linked to the space, or temporary structures such as an aircraft 22, in the case illustrated, placed in the space during a step of its production or of its inspection, for example.

The object 30, represented in FIG. 1 in the form of a mobile robot on the ground, that has to be located, also comprises at least one image acquisition device 31, such as a camera, borne by the object, an image acquisition device which is part of a locating system 100 for locating the object.

The image acquisition device 31 is borne by the object 30, preferably, but not necessarily, steerable to acquire images in different directions relative to a system of axes O′X′Y′Z′ linked to the object.

Generally, the image acquisition device of the object 30 can comprise one or more cameras, each camera being characterized, in addition to its fixed or variable position on the object, by a spectral domain and/or its capacity to restore depth information of the images that it supplies and by optical characteristics of a focal length which can be fixed with a wider or narrower field or which can be variable by discrete values or continuously. The video camera delivers, for example, data in two dimensions, 2D, and/or data in three dimensions, 3D, for a so-called depth camera.

As is known, orientation sensors (not represented), if appropriate position sensors (not represented), of each camera of the image acquisition device 31 determine, if appropriate after processing of the signals from the sensors, a position and a direction of observation of the camera in the system of axes O′X′Y′Z′ linked to the object 30. Direction of observation should be understood to mean a direction of an optical axis 311 culminating substantially at the center of an image formed by an optical system of the camera considered on an image sensor of the camera.

The image acquisition device 31, borne by the object 30, is associated with a data transmission device 110, in particular for data corresponding to the images and possibly to conditions of exposure by each camera of the image acquisition device, for example positions and orientations in the system of axes O′X′Y′Z′ linked to the object for each image.

The transmission of the data can be performed by any known transmission means, advantageously a wireless, radio or optical transmission system, adapted when the object to be located is an object moving around within the space 10, and also adapted to the environmental conditions in the space.

The system 100 for locating an object also comprises a computation center 101 adapted in particular for the processing of images, connected to the transmission device 110 via which it receives data from the object to be located and transmits data to the object.

The computation center 101 comprises, as is known, one or more computers and image processing programs for performing, on the received images, operations such as: shape recognitions; color and/or contrast recognitions; shape comparisons; image transformations; and image combinations to digitally reconstruct shapes of objects in three dimensions, this list not being exhaustive.

These types of operations applied to images are these days known to the person skilled in the art and the corresponding algorithms implemented will not be detailed here.

The computation center 101 also comprises one or more databases 105 of a digital representation of all or part of the real space 10 in which the object has to be located.

The database 105 comprises a database 102 of an initial digital representation of the real space 10.

The initial digital representation can be the result of computations to create a virtual representation of the real space, for example resulting from a three-dimensional digital model or from an assembly of digital models.

The initial digital representation can also be the result of the processing of images obtained in the real environment of the space 10, if necessary by introducing therein targets ensuring a better calibration of the data acquired in the real environment. Outline and shape recognition extraction algorithms are also advantageously implemented in this case.

These two methods, given as examples, for constructing the initial digital representation of the space are, if necessary, combined with one another, or combined with other techniques to acquire three-dimensional data of an environment, such as scanning laser range-finding, for example.

The computation center 101 also comprises complementary data of the representation of the space in which the object has to be located.

These complementary data, stored in one or more complementary databases 103, for example a sub-base of the database or databases 105 of the digital representation of the real space, are obtained from images transmitted by objects to be located situated in the real space.

The complementary data enrich the digital representation of the real space by adding information representative of real observation conditions which, while being consistent with the initial digital representation, will speed up the processing of the subsequent images by a learning process.

For example, the colors, the textures, the albedo of the different surfaces, lightings, reflections, transparencies are not necessarily perfectly represented in the initial digital representation, and all the more so when some of these features are variable in time and in space and highly sensitive to the observation conditions.

For example, changes to the real environment, for example movements of structures or of objects in the environment, “appearances” of new objects or “disappearances” of objects, are detected and recorded to ensure a continuous updating of the representation of the environment, advantageously reversible by a logging of the complementary data.

The complementary data are therefore obtained from the processing of the successive images transmitted by the image acquisition devices 31, implementing cameras 31 for example, and used to locate objects 30, each bearing an image acquisition device, in the space 10 by optical recognition of the visible shapes on the images and which are processed, on the one hand, to compute the point of the space 10 from which each image was generated by comparison with the digital model of the space stored by the locating system, and, on the other hand, to enrich the digital model of the real space with current data of the real space determined during the processing of each of the received images.

The implementation of the locating system therefore enriches the complementary data even more when the number of images processed for the locating computations increases, by virtue of multiple locatings of one and the same object moving around within the real space, and by virtue of the locating of different objects, present simultaneously in the real space or at different instants.

The use of shape recognition algorithms on a combination of the data of the initial representation and of the complementary data makes it possible to speed up the recognition and the accuracy of the identification of the shapes observed and therefore to speed up the computations and to enhance the accuracy of the locating derived from this recognition of the shapes on the processed images.

The implementation of the computation center, processing the images, and the database 105, remotely-sited to perform the computations and to determine a locating of the object in the real space, makes it possible to implement means that are unlimited, at least theoretically, in terms of volume and in terms of weight and in terms of energy requirement, to the benefit of computation powers which would not in practice be borne by the objects to be located themselves, at least when they are of small size such as rolling, flying, even floating small robots, processing means which ought also to be borne by each of the objects.

The computation center 101 is therefore able to accurately and rapidly compute the location of the object 30 for each image transmitted by the object and to retransmit this location to it, the only constraints being maintaining the links ensuring the transmissions of the data between the computation center and the object.

In practice, the number of images of the space 10 transmitted by one or more objects and processed by the computation center 101 of the locating system 100 will have been greater, and the accuracy and the rapidity of the locating computations will be further enhanced and these enhancements will instantaneously benefit each of the objects communicating with the processing center, transparently for each of the objects which will directly receive the information on its position, without the need for updates as would be necessary in the case of a database implemented in processing means embedded on the object.

Advantageously, the location of the object 30 is computed in different reference frames linked to the real space 10 and to the primary 14 and secondary 20 structures, then transmitted to the object 30 for the different reference frames, possibly for only some reference frames defined in a request from the object. The object 30 then has location information allowing it to manage its movements and/or its motions relative to the different structures of the real space 10.

For example, the location relative to reference frames linked to primary structures 14 allows the object 30 to manage overall movements within the real space 10, during which movements the secondary structures can be identified only as protected volumes, and the location relative to secondary structures 20 makes it possible to manage the motions of the object 30 in proximity to a secondary structure or during periods of work on a secondary structure during which the knowledge of an accurate relative location is necessary, even in the case of variability of the secondary structures.

It should be noted in this latter situation that while the visibility on an image transmitted by the object 30 of at least a part of the secondary structure, in relation to which a relative location is sought, is advantageous for the locating computations, this visibility is not essential. Indeed, in as much as the locating system 100 has processed a sufficient number of images transmitted previously by the object 30 to be located, or by other objects, the processing of an image showing all or part of at least one structure allows for locating in a reference frame linked to the structure and, through transformation matrices, makes it possible to compute the location data in a reference frame linked to an object not visible on an image, but whose accurate location will have been determined in relation to the absolute reference frame OXYZ by the images transmitted previously.

The computation center 101 having transmitted the location, resulting from the locating computations performed by the computation center, to the object 30 originating one or more images transmitted for this location, the object is then able to perform motions or movements as a function of tasks which are assigned to it, while continuing to receive location information updated on the basis of the successive images acquired and transmitted by the image acquisition system borne by the object.

The object is, for example, a robot, on the ground, or floating, or flying, which, for its operation, has to permanently and accurately know its position, or that of an effector, absolute within the environment in which it is moving around, or its relative position in relation to other objects or structures in the environment.

The robot can, for example, be a manipulating robot, an inspection robot, a robot assisting a human operator or another robot.

Through its image data processing power and databases, and by continuous enrichment of the complementary databases resulting from the processing of a growing number of images of the real environment received from the object to be located or advantageously from a plurality of objects to be located, the locating system is able to transmit to the object to be located not only an absolute position in the reference frame linked to the environment, but also a relative position in a reference frame linked to the structures appearing or not appearing in the images transmitted by the object or objects to be located.

When the structures of the environment are immobile and stable in the reference frame of the environment, the relative position and the absolute position are bijective.

However, in the industrial context of a workshop, some structures are not always in the same location of the environment of the workshop, either because the structure is mobile, such as, for example, an assembly frame or a heavy tool rig, or because the position of the structure exhibits a (legitimate) uncertainty, for example an aircraft on its landing gear, or placed on lifting jacks, whose position is only approximately defined, by comparison to the accuracy sought for the locatings of the object or objects, when the aircraft is put in place in the workshop, or even because the structure is variable, for example an aircraft which can correspond to different types by their dimensions and/or their shapes, or to different positions of mobile parts of a given aircraft, for example control surfaces of an airplane or a helicopter rotor.

In these conditions, the locating system, based on images received from the object or objects to be located, that it processes to determine the location of the objects to be located, permanently reconstructs a model of the real environment in which it corrects the effects linked to physical modifications of this environment, allowing it to give each object to be located the benefit of an absolute and relative location that is accurate and always optimized profiting from all of the information that the locating system determines from the images received from all the objects to be located.

The ongoing updating of the model of the real environment is done therefore in the invention without particular intervention from an operator on the locating system, for example to take account of the changes in the environment, such as, for example, the modified position of an aircraft or the type of aircraft.

The processing of data stored over prior periods makes it possible, in particular, to rapidly identify changes of the environment that may correspond to an earlier configuration of the space, specifically or approximately, already known to the locating system. The reconstruction of the model of the environment with the new images transmitted by the objects to be located is then much faster to achieve the necessary accuracy levels.

In particular applications, the real space 10 comprises one or more secondary structures 20, 21 and is not associated with any primary structure (either there is none in the space 10 or it is not considered), or else comprises a primary structure 14 and is not associated with any secondary structure (either there is none in the real space 10 or they are not considered).

In these application cases, the position of the object is established in one or more reference frames linked to the structure or structures referenced in the real space 10.

The absence of a secondary structure corresponds, for example, to the case of the locating of an object in a fixed environment, such as an empty hangar, for example, for the purposes of guiding the object to place it on station or for conveying.

The absence of primary structure corresponds, for example, to the case where only a location relative to a secondary structure is sought and in which a primary structure, if it exists, does not have any feature that makes it possible to improve the quality of the location sought.

Thus, the locating system of the invention is a locating system using the visual recognition techniques and providing one or more objects to be located with computation and image processing capacities which would be difficult, if not impossible in practice, to incorporate in each object to be located, and which uses the images transmitted by all the objects to be located to refine and permanently update a digital model of the real space in which the objects to be located move around and more rapidly to determine the locations of the objects to be located with an enhanced accuracy compared with known locating systems based on visual recognition.

Through its structure and its algorithms, the locating system, from an initial configuration in which it has a first model of the real space in which objects to be located have to move around, enriches the environment model with images, or results of the processing thereof, transmitted from the objects to be located and determines locations with computation times and accuracies that are constantly improving over time as and when new images are processed to determine the positions of objects to be located by recognition of the shapes observed in the new images transmitted and computations of the point of the space from which each image was generated by the image acquisition device.

Although the locating system based on image processing of the invention is able to restore an accurate location to each object, the implementation of the system of the invention does not preclude an object from having autonomous locating means, for example for locating in an absolute reference frame by triangulation or trilateration, or by odometry.

The transmission by an object of its position, measured or estimated, to the image computation center 101 makes it possible, in particular, to simplify, and therefore to speed up, the computation of position to be transmitted by the processing center to the object, and also to detect inconsistencies that might reflect inaccuracy or failure of a component of the locating system.

Locating means embedded on the object also make it possible to ensure autonomous guidance in degraded mode in the event of loss of communication with the image processing center or impossibility of transmitting images, for example, following damage to the image sensor.

In one embodiment, the locating system is coupled to a supervision system 120 which uses the database 105 of the real environment 10 and the position information of each of the objects to reconstruct, advantageously in real time, on one or more screens, a virtual representation of the real space 10, with the structures and the objects that it contains, from one or more points of observation of the space, for example a point of observation chosen by an operator.

The locating system 100 described is advantageously used to implement a method 200 for locating at least one object 30 in at least one reference frame of the real space 10 in which the object is located, and in which it moves around, if appropriate.

According to the method, at the following steps are implemented.

In a preliminary step 201, an initial digital model of a representation of the real space 10 is generated. The initial digital model is a virtual expression of the real space in which the structures, at least for the main structures likely to serve as references in the position computations, of the real space are represented.

The initial digital model is, for example, obtained from a digital model. The digital model can also be the result of a more or less detailed digitization of the real space in three dimensions, for example by laser range-finding, projection embossing or processing of images of the visible domain.

In a recurrent uplink transmission step 202, data representative of an image of the real space 10, acquired from a point of observation linked to the object 30 having to be located, are transmitted to the computation center 101. The images of the real space are acquired by the image acquisition device 31 of the object, a device that can comprise one or more cameras, if necessary lighting means in a visible or non-visible, for example infrared, light range. The images acquired are converted into data for their transmission, advantageously into digital data for a reduced sensitivity to the disturbances and interferences that can be encountered in the real space 10.

In a processing step 203, the data representative of an image, acquired by the image acquisition device 31 and received by the computation center 101, are processed by the computation center to determine, in the virtual representation of the real space, a position from which, if appropriate, a direction in which the image was acquired in the real space 10.

For a first image, the initial virtual representation of the real space is used, but advantageously for the following iterations of processing of the data of the successive images, an enriched virtual representation, incorporating data on the real space determined by the processing of the images, is implemented.

The determination of the position from which the image was acquired in the real space is theoretically equivalent to determining, in the virtual representation of the real space, a point from which a computer-generated image of the virtual representation is identical to the acquired image, this point being able to be transposed like the location sought in the real space. In practice, the identity between the computer-generated image and the acquired image is never perfect and the person skilled in the art will implement known techniques, in particular correlations and probabilities, to identify the location with the expected level of quality. Such methods, when they use iterative computations, converge more rapidly when an estimated position of the object 30 is otherwise known, when this estimated position is transmitted with the acquired image data or when this position results from prior locating computations for the same object.

In a downlink transmission step 204, the location data, comprising position data and, if appropriate, direction data of an axis 311 of observation, obtained in the image processing step 203, are transmitted to the object 30 having transmitted the image.

This transmission is advantageous when the object 30 concerned is a mobile object implementing an autonomous guidance system which will then use the location data received.

In other implementations, the mobile object is remote-controlled by a control center, which case is not represented, and then the location data will be transmitted, for example by a communication network, to the control center, a hybridized solution of the two location data transmission modes being of course possible for the purposes of hybridization of the control or for the purposes of redundancies or surveillance.

In an enrichment step 205, the digital model of the virtual representation of the real space 10 is enriched by incorporation in the digital model of data extracted in the processing step 203.

Indeed, each image, or at least some of the images, whose data are received by the computation center 101, is a view, a priori partial, of the real space 10 as the real space may be perceived by the image acquisition device at the moment when the image is acquired.

This perception of the real space 10 can be different from that of the digital model of the virtual representation of the real space.

It can be different because the virtual representation of the real space is not totally exact, either because the digital model is simplified, or because it includes errors.

It can be different because the real space 10, at the moment of acquisition of the image, effectively underwent transformations, for example through modifications of shapes, and/or of placement, and/or of color, and/or of any other feature observable by the image acquisition device, or even by structures having been removed from the real space or structures having been added in the real space.

It can be different also because the conditions of observation of the real space 10 have been modified, for example because of changes in the lighting conditions or through the presence of spray in the air of the real space, giving the real space a different appearance even in the absence of material modification of the real space.

In this context, the computation center 101, having identified an image of the real space as corresponding to a part, from a position and according to a direction, of the virtual representation of the real space, will perform a processing of the data of the images to extract information to complement, correct or update, and generally enrich, the data of the virtual representation in the database 105.

In a first cycle of processing of the data representative of the images, the enriched data are those of the initial virtual representation of the real space. In the subsequent processing cycles, the enriched data are aggregated such that the virtual representation of the real space is continually refined, enriched and updated.

Advantageously, the enrichment data are logged so as to track the changes to the virtual representation of the real space which can be subjected to cyclical variations, for example phases of activity leading to tool rig movements, for example lighting variations linked to day/night alternations and to the different periods of the year. A logging thus makes it possible to temporarily restore data of the virtual representation in the conditions of the moment.

Generally, at least for an object 30 that is moving, the aim is to provide the location of an object 30, or of each of the objects of a plurality of objects, continuously, that is to say, with a sufficient frequency for each object for its trajectory to be able to be identified with an accuracy required for the operations that have to be carried out by the object.

The step of uplink transmission 202, of processing 203, of downlink transmission 204 and of enrichment 205 are therefore performed cyclically to supply the location data of all or some of the images received by the computation center 101.

The invention thus makes it possible to give all the objects to be located the benefit of the information, resulting from a processing of the images, received by the image processing center, of the real space seen by each of the objects to be located.

It also allows an ongoing updating of the digital model representing the space, without intervention from an operator, by the images transmitted by all the objects to be located, and to the benefit of each of the objects to be located, which are able to receive the data on their locations more rapidly, more accurately, and without it being necessary to have an autonomous locating means embedded on the object.

The example presented of a workshop hangar for aircraft and of a mobile robot in the hangar is not limiting on the invention.

In as much as an object has to be located in an environment exhibiting a relative stability, at the very least a sufficiently “slow” rate of change with respect to the possible enrichment according to the principles of the invention, the person skilled in the art will be able to apply the principles of the invention explained above.

In a non-limiting manner, the invention will be able to be implemented to locate a vehicle in a more or less open space, whether this vehicle is moving on the ground, on water or in flight.

The invention will also be able to be implemented to locate a terminal element of a robot having to move the terminal element around in the real space, for example bearing a tool, for example to a structure in a system of axes of which the location data will be computed.

The invention, by using essentially optical sensors, is able to deliver highly accurate location data by dispensing with the effects of disturbance or of propagation defects known with other technologies, in particular implementing electromagnetic or acoustic waves.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for locating at least one object in a real space by image processing, comprising:
a computation center,
said computation center comprising at least one database of a virtual environment which comprises a virtual representation of the real space,
at least one image acquisition device borne by the at least one object,
wherein the locating of the at least one object comprises computation of a position of a point of the virtual environment from which said virtual environment is seen as represented on at least one image of the real space obtained by the at least one image acquisition device,
wherein the computation center is remotely-sited relative to the at least one object and the locating system comprises a data transmission device configured to perform a transfer of data representative of images from the at least one object to the computation center and the transfer of location data from said computation center to said object,
wherein said computation center is configured to perform a processing of the data, representative of an image of the real space transmitted by the data transmission device from at least one object, to determine, in the virtual environment, a position of a point of the real space from which the image was acquired, and transmits, via the data transmission device to said at least one object, location data of said point comprising data of said position,
wherein said computation center stores, in a complementary database, processed data of the image of the real space, acquired by the image acquisition device, which at least one of complement or correct an initial database of an initial digital representation of the real space to constitute a database of an enhanced digital representation of said real space.

2. The system according to claim 1, in which the computation center is also configured to perform a processing of the data, representative of an image of the real space transmitted by the data transmission device from the at least one object, to determine, in the virtual environment, a direction of an axis of observation towards which the real space is viewed, from the point of said real space from which the image was acquired, and transmits, to said at least one object, the location data of said point comprising direction data of the axis of observation.

3. The system according to claim 1, comprising a plurality of image acquisition devices, configured to be borne by objects to be located situated in the real space at one and the same instant and/or at different instants.

4. The system according to claim 1, wherein the data transmission device is a wireless transmission device.

5. The system according to claim 1, wherein the locating system comprises at least one autonomous locating device configured to be borne by the at least one object and associated with the at least one image acquisition device so as to associate primary location data with the acquired images.

6. The system according to claim 1, wherein the image acquisition device configured to be borne by the at least one object comprises at least one video camera delivering data in two dimensions, and/or a depth camera delivering data in three dimensions.

7. The system according to claim 1, further comprising a supervision station which uses the database of the virtual environment and the location data of the object or objects to reconstruct, on one or more screens, a visual representation of the virtual space, comprising representations of structures and of objects of the real space, or in said real space, seen from at least one point of observation set arbitrarily or chosen by an operator.

8. A method for locating at least one object in a real space in which said at least one object is located, said method comprising:
a) creating an initial virtual representation of the real space, hosted in a database of a computation center separate from the at least one object, then;
b) transmitting, to the computation center, data representative of an image of the real space acquired from a point of observation linked to the object, then;
c) processing, by the computation center, of said data representative of said image to determine, in an initial virtual representation of the real space or in an enriched virtual representation of said real space, a position from which said image was formed in the real space, and;
d) enriching a digital model of the initial or an enriched virtual representation of the real space by incorporation, in said digital model, of data of the real space extracted from the data representative of said image transmitted in the transmitting step.

9. The method according to claim 8, wherein the step of processing by the computation center of the data representative of the transmitted image comprises determining, in the virtual representation of the real space, a direction of an axis of observation towards which the real space is viewed, from the point of said real space from which the image was acquired.

10. The method according to claim 8, further comprising, after the processing step, a step of transmitting, by the computation center, location data comprising position data determined in said processing step, from which the image was formed in the real space, if appropriate, direction data of an axis of observation.

11. The method according to claim 8, wherein the data of the real space, incorporated in the step of enriching in the digital model of the virtual representation of the real space, comprise primitives generated from appearance attributes out of contrasts, colors, transparencies, reflections, textures, depth measurements.

12. The method according to claim 8, wherein the data of the real space, incorporated in the step of enriching in the digital model of the virtual representation of the real space, comprise data relating to structures of said real space added to and/or deleted from and/or moved in said real space.

13. The method according to claim 8, wherein images of the real space are acquired successively from a point of observation linked to the at least one object and transmitted sequentially to the computation center, and in which the steps of processing and of enrichment are performed recurrently with all or some of the images transmitted sequentially.

14. The method according to claim 8, in which a plurality of objects are located simultaneously and/or sequentially.

15. The method according to claim 8, the enriching of the digital model of the initial or enriched virtual representation of the real space includes storing the data in a complementary database, and wherein the data stored in the complementary database are aggregated and conserved in an enrichment log of an initial database.
